(19) United States
(12) Patent Application Publication
(10) Pub. No.: US 2001/0036564 A1
(43) Pub. Date: Nov. 1, 2001

(54) Magnetic recording medium and manufacturing method thereof

(75) Inventor: Hiroyuki Ohmori, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation.

(21) Appl. No.: 09/816,548

(22) Filed: Mar. 26, 2001

(30) Foreign Application Priority Data
Mar. 31, 2000 (JP) P2000-101350

(51) Int. Cl. G11B 5/64

(52) U.S. Cl. 428/694 TS

(57) ABSTRACT

The magnetic recording medium comprises: a non-magnetic substrate; a non-magnetic metal ground layer formed on a main surface side of the non-magnetic substrate and containing Ru at 20 at % or more; and a magnetic layer formed on the non-magnetic metal ground layer and having a metal magnetic thin film.

### BACKGROUND OF THE INVENTION

The present invention relates to a magnetic recording medium and a manufacturing method thereof.

There is a conventionally known magnetic recording medium which comprises, as a magnetic layer for performing magnetic recording, a metal magnetic thin film formed by a vapor deposition method, a spattering method, or the like. For example, Co and Pt or Cr as main components added with various elements such as Ta, Ti, and the like are mainly used for the magnetic layer, as described in Japanese Patent Application Laid-Open Publications No. 9-259419, No. 9-245337, and the like.

Meanwhile, low noise and high coercive force have been expected and desired for the magnetic layer of this kind of magnetic recording medium in order to achieve recording with a higher density. Particularly, in in-plane magnetic recording, heat demagnetization is a significant problem so that the magnetic layer requires higher coercive force. In general, a method of using an intermetallic compound having crystal magnetic isotropy has been considered to increase the coercive force of the magnetic layer.

For example, there are an intermetallic compound made of a magnetic element such as Co or the like and a rare-earth element such as Sm or the like, as described in Japanese Patent Application Laid-Open Publication No. 10-255249, and an intermetallic compound made of Co and Pt.

Vertical magnetic recording has been proposed as a method which is less influenced from the heat demagnetization. As described in Japanese Patent Application Laid-Open Publication No. 1-251356, Co and Pt or Pd are alternately layered to form the magnetic layer in a sequential layered structure. In this manner, a vertical medium can be realized.

Meanwhile, as described above, an intermetallic compound having crystal magnetic isotropy such as CoSm alloy, CoPt alloy, or the like may be used to obtain a magnetic layer with high coercive force. However, film formation at a relatively high temperature or a heat treatment after film formation is necessary to obtain regulated crystalline for the intermetallic compound. That is, the magnetic recording medium must be exposed under a condition of a relatively high temperature, in case of using CoSm alloy or CoPt alloy to obtain high coercive force of a magnetic layer.

However, if the magnetic recording medium is exposed under the condition of a relatively high temperature, the size of crystal grains in the magnetic layer increases, and as a result, noise is increased. Although a vertical magnetic recording medium in which Co and Pt or Pd are sequentially layered does not require a heating process, the noise of the medium is larger, for example, as described in Journal of Magnetic Society of Japan VOL 18, Supplement, No S1 (1994) p. 103.

### BRIEF SUMMARY OF THE INVENTION

The present invention hence has been proposed in view of the above situation of the prior art and has an object of providing a magnetic recording medium which has high coercive force, creates sufficiently low medium noise, and performs recording/reproducing at a high signal-to-noise ratio (S/N) even in high-density recording, and a method of manufacturing the same.

A magnetic recording medium which achieves the above object according to the present invention comprises: a non-magnetic substrate; a non-magnetic metal ground layer formed on a main surface side of the non-magnetic substrate and containing Ru at 20 at % or more; and a magnetic layer formed on the non-magnetic metal ground layer and having a metal magnetic thin film.

The magnetic recording medium according to the present invention, which is constructed as described above, comprises a non-magnetic metal ground layer containing Ru at 20 at % or more, so that the crystal orientation of the magnetic layer is improved. As a result, the magnetic layer has high coercive force. Also, the magnetic recording medium comprises a non-magnetic metal ground layer which contains Ru at 20 at % or more, so that the magnetic interaction between magnetic grains in the magnetic layer can be reduced. As a result, the magnetic recording medium reduces noise component.

A method of manufacturing a magnetic recording medium, according to the present invention, comprises: a step of forming a non-magnetic metal ground layer containing Ru at 20 at % or more, on one main surface side of the non-magnetic substrate, under a condition of 100° C. or less; and a step of forming thereafter a magnetic layer having a metal magnetic thin film, on the non-magnetic metal ground layer, under a condition of 100° C. or less.

In the manufacturing method according to the present invention, which is arranged as described above, a magnetic layer having high coercive force can be formed even when a non-magnetic metal ground layer and the magnetic layer are each formed at a temperature of 100° C. or less, because the magnetic layer is formed on the non-magnetic metal ground layer containing Ru at 20 at % or more. Also, according to this method, it is possible to prevent enlargement of the size of magnetic crystal grains caused by applying a high temperature, so that a magnetic layer containing less noise component can be formed.

As has been explained above, the magnetic recording medium according to the present invention has a non-magnetic metal ground layer containing Ru at 20 at % or more on one surface side of the non-magnetic substrate, and a magnetic layer on the non-magnetic metal ground layer. Therefore, the coercive force of the magnetic layer is high, and the noise component is reduced. Accordingly, it is possible to perform recording/reproducing at a high signal-to-noise ratio (S/N) even in high-density recording.

In the method of manufacturing a magnetic recording medium, according to the present invention, a non-magnetic metal ground layer containing Ru at 20 at % or more is formed on a non-magnetic substrate under a condition of 100° C. or less, and thereafter, a magnetic layer having a metal magnetic thin film is formed on the non-magnetic metal ground layer under a condition of 100° C. or less. Therefore, according to this method, it is possible to prevent securely enhancement of noise component due to heating over 100° C.

In the manufacturing method according to the present invention, which is arranged as described above, a magnetic layer having high coercive force can be formed even when a non-magnetic metal ground layer and the magnetic layer are each formed at a temperature of 100° C. or less, because the magnetic layer is formed on the non-magnetic metal ground layer containing Ru at 20 at % or more. Also, according to this method, it is possible to prepare a magnetic recording medium capable of performing recording/reproducing at a high signal-to-noise ratio (S/N) in high-density recording.

### BRIEF DESCRIPTION OF THE SEVERAL VIEWS OF THE DRAWINGS

FIG. 1 is a cross-sectional view of a main part, showing a structural example of a magnetic recording medium according to the present invention;

FIG. 2 is a characteristic graph showing a relationship between the addition amount of an element of the first group and the coercive force of the magnetic layer;

FIG. 3 is a characteristic graph showing a relationship between the addition amount of an element of the first group and the coercive force of the magnetic layer;

FIG. 4 is a characteristic graph showing a relationship between the addition amount of an element of the second group and the coercive force of the magnetic layer;

FIG. 5 is a characteristic graph showing a relationship between the addition amount of an element of the third group and the coercive force of the magnetic layer;

FIG. 6 is a characteristic graph showing a relationship between the thickness of the non-magnetic metal ground layer and the coercive force of the magnetic layer;

FIG. 7(a) is a characteristic graph showing a reproduced signal waveform in a magnetic recording medium having a non-magnetic metal ground layer made of Ru₁₀₀, and

FIG. 7(b) is a characteristic graph showing a reproduced signal waveform in a magnetic recording medium having a non-magnetic metal ground layer made of Ru₉₇O₃;

FIG. 8(a) is a characteristic graph showing a reproduced magnetization curve in a magnetic recording medium having a non-magnetic metal ground layer made of Ru₁₀₀, and

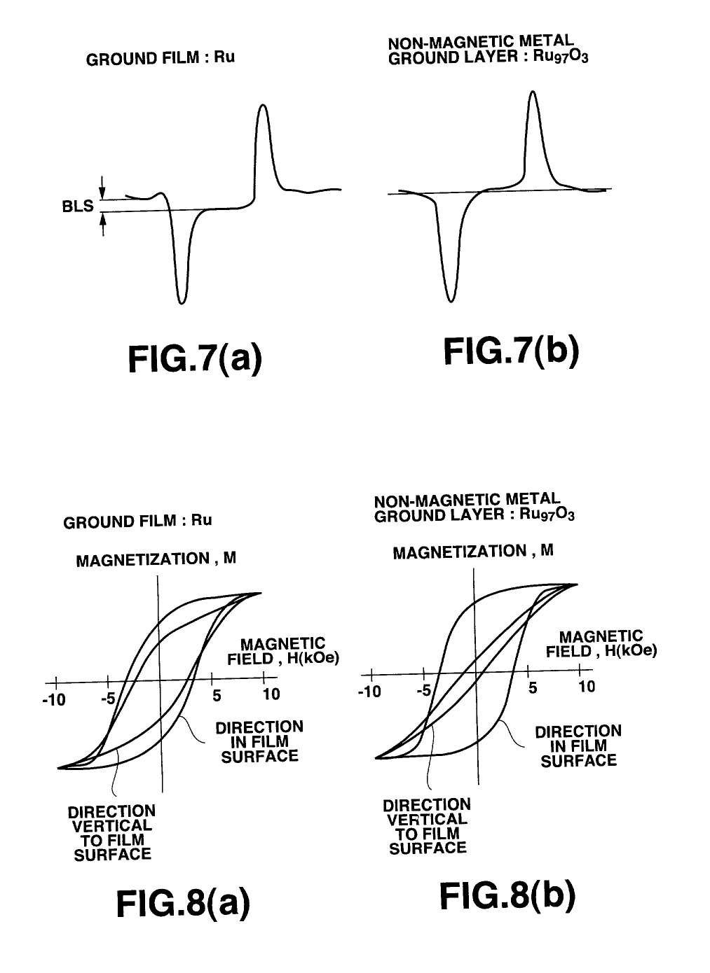

FIG. 7(b) is a characteristic graph showing a magnetization curve in a magnetic recording medium having a non-magnetic metal ground layer made of Ru₉₇O₃;

FIG. 9 is a characteristic graph showing the relationship between the linear recording density and the standardized noise in a magnetic recording medium having a non-magnetic metal ground layer having a granular structure and in a magnetic recording medium having a Cr ground layer;

FIG. 10 is a characteristic graph showing the relationship between the composite ratio of a magnetic layer and the coercive force of the magnetic layer in a plurality of magnetic recording media whose non-magnetic metal ground layers made of Ru₁₀₀ have varied thicknesses;

FIG. 11 is a characteristic graph showing the film thickness of the magnetic layer and the coercive force of the magnetic layer;

FIG. 12 is a cross-sectional view of a main part, showing another structural example of the magnetic layer;

FIG. 13 is a characteristic graph showing the relationship between the film forming gas pressure and the coercive force in the vertical direction in a magnetic recording medium having a non-magnetic metal ground layer made of Ru₁₀₀ and in a magnetic recording medium having a Pd ground layer; and

FIG. 14 is a characteristic graph showing the relationship between the linear recording density and the standardized noise in a magnetic recording medium having a non-magnetic metal ground layer made of Ru₁₀₀ and in a magnetic recording medium having a Pd ground layer.

### DETAILED DESCRIPTION OF THE INVENTION

In the following, specific embodiments of a magnetic recording medium according to the present invention and a manufacturing method thereof will be explained in details with reference to the drawings.

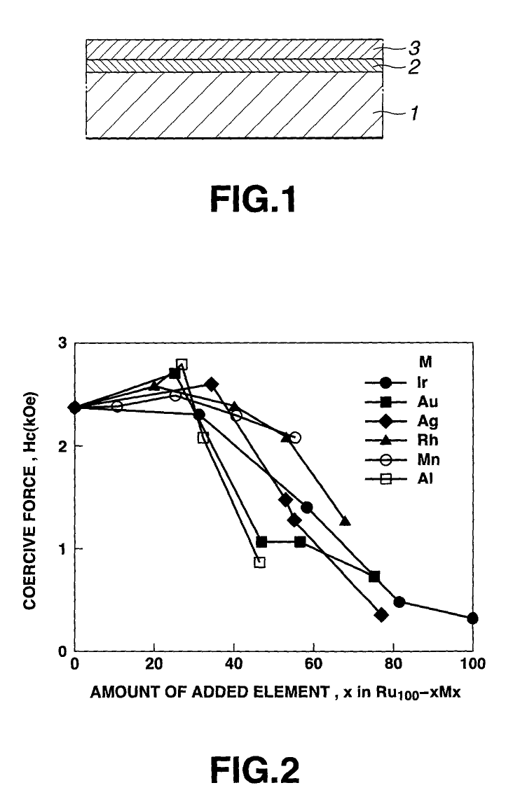

As shown in FIG. 1, the magnetic recording medium to which the present invention is applied comprises a non-magnetic substrate 1, a non-magnetic metal ground layer formed on the substrate 1 and containing Ru at a ratio of 20 at % or more, and a magnetic layer 3 formed on the non-magnetic metal ground layer 2 and having a metal magnetic thin film. In this magnetic recording medium, a film made of one of elements Cr, Mo, W, Ti, Ta, V, Nb, Zr, Hf, B, C, and Si or made of alloy of any of these elements may be formed between the non-magnetic substrate 1 and the non-magnetic metal ground layer 2 for the purpose of improving the adhesion between the non-magnetic substrate 1 and the non-magnetic metal ground layer 2, although not shown in the figure.

In this magnetic recording medium, the non-magnetic metal ground layer 2 contains Ru at 20 at % or more, so that the coercive force of the magnetic layer 3 can be increased greatly. Further, the non-magnetic metal ground layer 2 has a function of weakening magnetic interaction between magnetic grains forming the magnetic layer 3 thereby to reduce the medium noise.

The non-magnetic metal ground layer 2 contains Ru at 20 at % or more. In other words, the non-magnetic metal ground layer 2 may contain another kind of element than Ru, at 80 at % or less.

As the element other than Ru, which is contained in the non-magnetic metal ground layer 2, may be at least one kind of element selected from a group of Cr, Ti, Ta, Zr, Hf, Fe, Co, Mn, Si, Al, Ag, Au, and Ir (hereinafter called a first group). That is, the non-magnetic metal ground layer 2 may be alloy of Ru and an element of the first group. Particularly in case of using alloy of Ru and an element of the first group, the composite ratio of Ru is 50 at % or more.

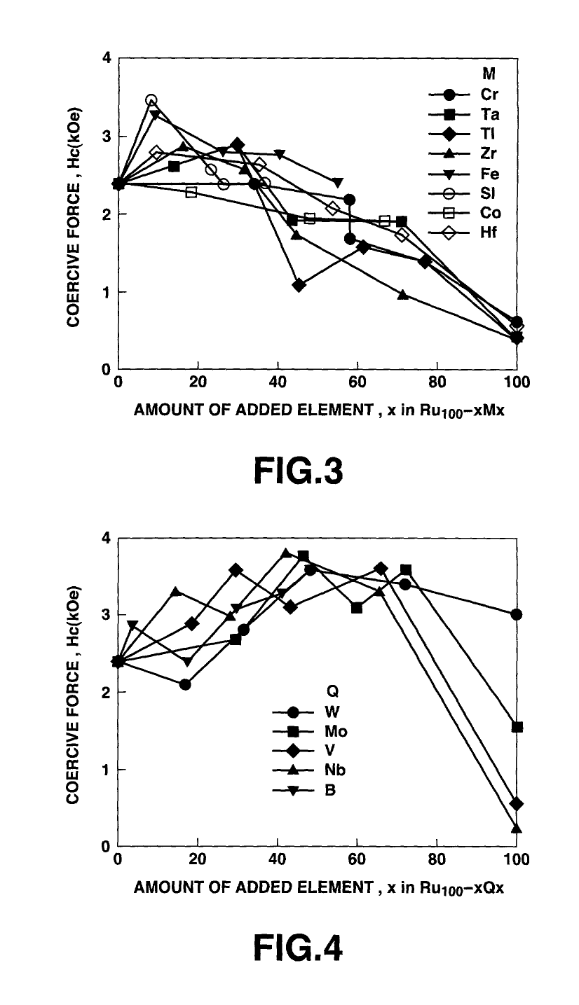

With respect to a magnetic recording medium using the alloy made of Ru and an element of the first group (where the alloy is expressed as a general expression of Ru₁₀₀₋ₓMₓ and M is an element of the first group) as the non-magnetic ground layer 2, FIGS. 2 and 3 shows the relationship between x in the general expression and the coercive force of the magnetic layer 3. As can be seen from FIGS. 2 and 3, improvement of the coercive force is found when the ratio of the element of the first group is up to about 20 at %. However, when the ratio of the element of the first group exceeds 20 at %, the coercive force rapidly decreases. Hence, if the alloy of Ru and an element of the first group is used for the non-magnetic metal ground layer 2, it is found that the content ratio of Ru in the composition of the alloy should be preferably set to 50 at % or more.

In the experiments shown in FIGS. 2 and 3, the composition of the magnetic layer 3 is Co₇₀—Ni₁₀—Pt₂₀, the film thickness of the magnetic layer 3 is set to 15 nm, and the film thickness of the non-magnetic metal ground layer 2 is set to 20 nm. Also, in FIGS. 2 and 3, the lateral axis represents the ratio of the element of the first group in at %, and the longitudinal axis thereof represents the in-plane coercive force in kOe.

The element other than Ru, which is contained in the non-magnetic metal ground layer 2, will be at least one kind of element selected from a group of W, Mo, V, Nb, and C (hereinafter called a second group). Particularly in case where the non-magnetic metal ground layer 2 is alloy of Ru and an element of the second group, the composite ratio of Ru should preferably be 20 at % or more.

With respect to a magnetic recording medium using the alloy made of Ru and an element of the second group (where the alloy is expressed as a general expression of Ru₁₀₀₋ₓQₓ and Q is an element of the first group) as the non-magnetic ground layer 2, FIG. 4 shows the relationship between x in the general expression and the coercive force of the magnetic layer 3. As can be seen from FIG. 4, improvement of the coercive force is found when the ratio of the element of the second group is up to about 80 at %. However, when the ratio of the element of the second group exceeds 50 at %, decrease of the coercive force is found. Hence, if the alloy of Ru and an element of the second group is used for the non-magnetic metal ground layer 2, it is found that the composite ratio of Ru in the alloy should be preferably set to 20 at % or more.

Further, an element other than Ru, which is contained in the non-magnetic metal ground layer 2, is at least one kind of element selected from a group of Cu, Ni, Pd, Pt, Y, and C (hereinafter called a third group). Particularly in case where the non-magnetic metal ground layer 2 is alloy made of Ru and an element of the third group, the composite ratio in the alloy is 80 at % or more.

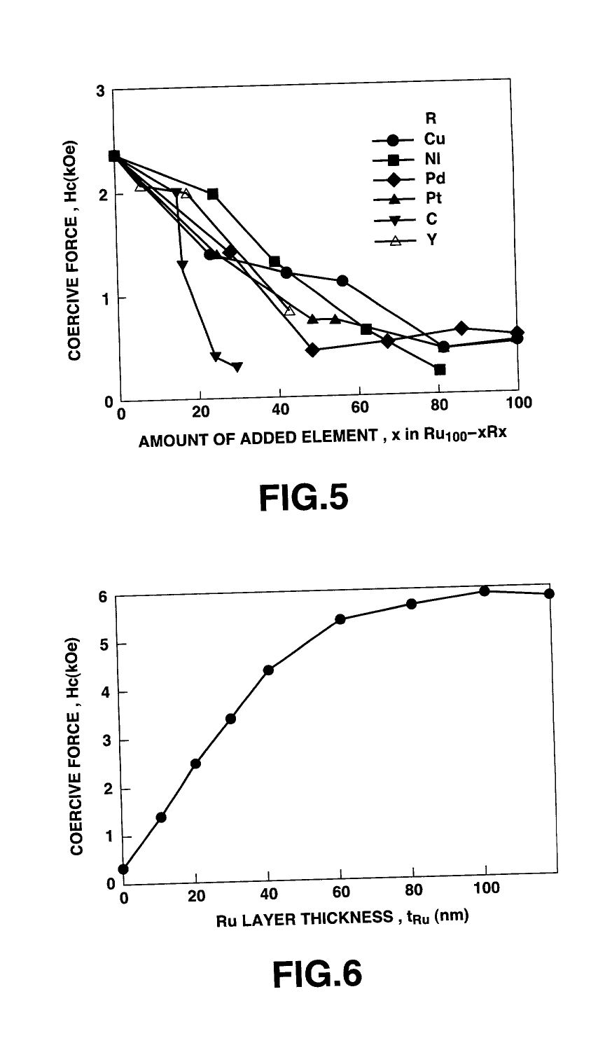

With respect to a magnetic recording medium using the alloy made of Ru and an element of the third group (where the alloy is expressed as a general expression of Ru₁₀₀₋ₓRₓ and R is an element of the first group) as the non-magnetic ground layer 2, FIG. 5 shows the relationship between x in the general expression and the coercive force of the magnetic layer 3. As can be seen from FIG. 5, the coercive force of the magnetic layer 3 is slightly lowered, compared with the case of using only Ru. However, when the ratio of the element of the third group is about 20 at %, the rate of decrease of the coercive force is not so large that the magnetic layer 3 has sufficiently allowable coercive force. Hence, if the alloy of Ru and an element of the third group is used for the non-magnetic metal ground layer 2, it is found that the composite ratio of Ru in the alloy should be preferably set to 80 at % or more.

As shown in FIGS. 2 to 5, the magnetic recording medium to which the present invention is applied comprises the non-magnetic metal ground layer 2 containing Ru at 20 at % or more, so the coercive force of the magnetic layer 3 is improved.

Also, in the magnetic recording medium, the coercive force of the magnetic layer 3 was measured while changing the film thickness of the non-magnetic metal ground layer 2 made of Ru, in order to certify the effect that the non-magnetic metal ground layer 2 made of Ru improves the coercive force of the magnetic layer 3. At this time, in order to improve contact tightness between the non-magnetic metal ground layer 2 and the non-magnetic substrate 1, a medium was used in which a Cr ground film with a thickness of 10 nm was provided and a non-magnetic metal ground layer 2 made of Ru and a Co₇₀Ni₁₀Pt₂₀ having a thickness of 10 nm are provided in this order on the Cr ground film. The results are shown in FIG. 6.

As can be seen from FIG. 6, if a non-magnetic metal ground layer 2 which contains even a slight amount of Ru was formed, the coercive force of the magnetic layer 3 was improved in comparison with the case where the thickness of the non-magnetic metal ground layer 2 is 0 nm, that is, a magnetic layer 3 was formed on the Cr ground film. In particular, it is found that the effect of improving the coercive force of the magnetic layer 3 is great if the film thickness of the non-magnetic metal ground layer 2 was 2 nm or more. Also, there is a tendency that further improvement the coercive force of the magnetic layer 3 cannot be expected any more if the film thickness of the non-magnetic metal ground layer 2 exceeds 100 nm. If the film thickness of the non-magnetic metal ground layer 2 exceeds 100 nm, the film quality of the non-magnetic metal ground layer 2 is degraded so that the mechanical characteristics are deteriorated. It is hence found that the coercive force of the magnetic layer 3 is effectively improved and excellent mechanical characteristics are achieved when the non-magnetic metal ground layer 2 has a thickness of 2 nm to 100 nm.

Further, the non-magnetic metal ground layer 2 may be made by layering a plurality of layers having different compositions of Ru and an element other than Ru or may have a graded composition in which the composition of Ru and an element other than Ru is changed continuously. In any of these cases, the non-magnetic metal ground layer 2 can improve the effect of improving the coercive force of the magnetic layer 3.

Meanwhile, this non-magnetic metal ground layer 2 may contain oxygen and/or nitrogen. By containing oxygen and/or nitrogen in the non-magnetic metal ground layer 2, the magnetic recording medium can adjust the crystal orientation, crystal grain size, and the like so that control of the magnetic characteristics of the magnetic layer 3 can be easily realized. In particular, the non-magnetic metal ground layer 2 should preferably contain oxygen and/or nitrogen at a ratio of 0.2 to 10 at %. If the ratio of oxygen and/or nitrogen contained in the non-magnetic metal ground layer 2 is lower than 0.2 at %, there is a possibility that the effect of controlling the magnetic characteristics of the magnetic layer 3 cannot be expected. Also, if the ratio of oxygen and/or nitrogen contained in the non-magnetic metal ground layer 2 exceeds 10 at %, the coercive force of the magnetic layer 3 may be reduced.

Specifically, FIG. 7 shows results of having measured reproduced signal waveforms as magnetic characteristics of the magnetic layer 3 in cases where the non-magnetic metal ground layer 2 was made of Ru₁₀₀ and where the non-magnetic metal ground layer 2 was made of Ru₉₇O₃. In FIG. 7, Co₇₇Pt₁₅P₈ with a film thickness of 12 nm was used as the magnetic layer 3.

As can be seen from FIG. 7, if the non-magnetic metal ground layer 2 made of Ru₁₀₀ which does not contain oxygen is used, there appears a phenomena (baseline shift) that a flat portion of the reproduced signal shifts before and after an isolated wave. If the baseline shift is too large, the error rate is deteriorated undesirably. In contrast, if the non-magnetic metal ground layer 2 made of Ru₉₇O₃ formed in an oxygen containing atmosphere is used, the baseline shift is greatly reduced.

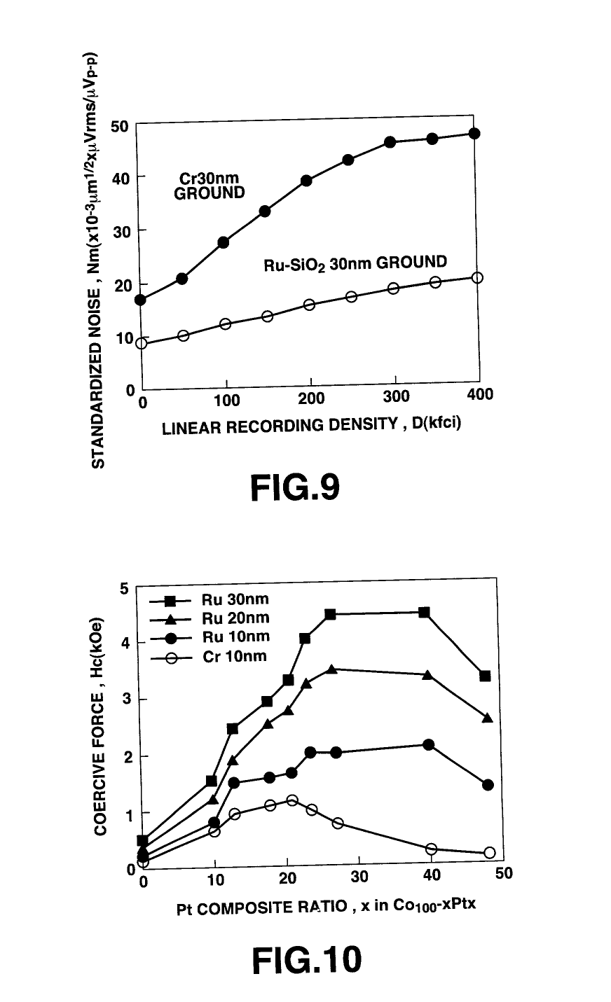

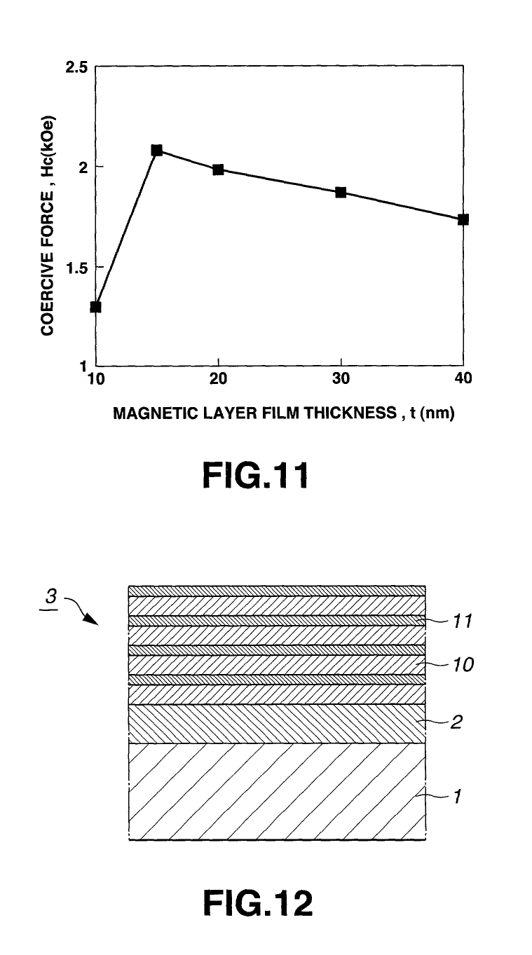

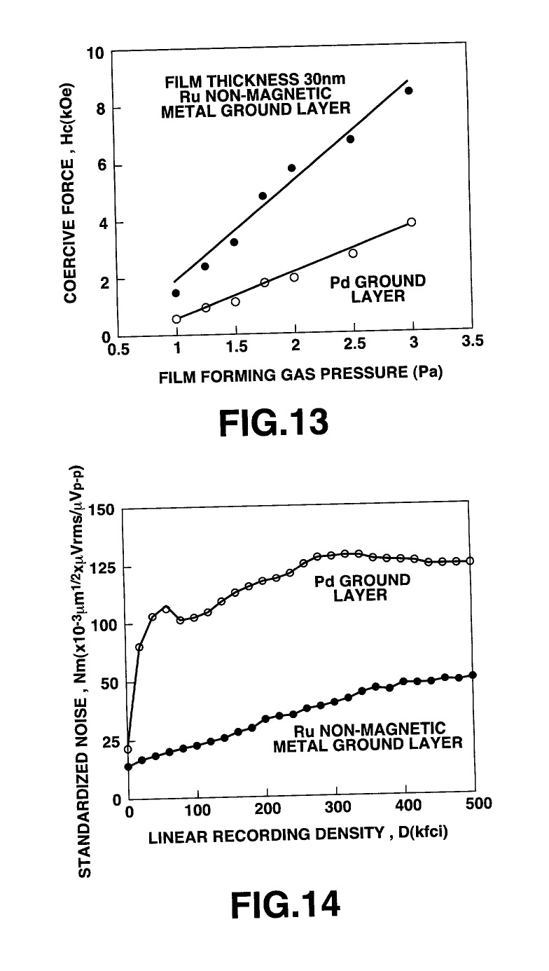

Also, FIG. 8 shows results of having measured magnetization curves with respect to the magnetic layer 3 formed on the non-magnetic metal ground layer 2 made of Ru₁₀₀ and the magnetic layer 3 formed on the non-magnetic metal ground layer 2 made of Ru₉₇O₃. In case of the non-magnetic metal ground layer 2 made of Ru₁₀₀, great coercive force and residual magnetization are found also in the direction vertical to the film surface. In contrast, in case of the non-magnetic metal ground layer 2 made of Ru₉₇O₃, both the coercive force and residual magnetization in the direction vertical to the film surface decrease. Hence, it can be found easily that the crystal orientation of the magnetic layer 3 can be changed by adjusting the oxygen amount to be contained in the non-magnetic metal ground layer 2.

Further, the non-magnetic metal ground layer 2 is made by layering layers having different ratios of oxygen and/or nitrogen or may have a graded composition in which the ratio of the oxygen and/or nitrogen is changed continuously. In any of these cases, the non-magnetic metal ground layer 2 can more improve the effect of improving the coercive force of the magnetic layer 3.

Meanwhile, since Ru tends to form less oxide or nitride in comparison with Si, Al, or the like, it is possible to form a structure in which at least one selected from a group of oxide, nitride, carbide, and carbon is finely compounded, i.e., a granular structure, if at least one selected from a group of oxide, nitride, carbide, and carbon is added to the non-magnetic metal ground layer 2. By constructing the non-magnetic metal ground layer 2 in this granular structure, much more noise reduction of the magnetic recording medium can be realized.

Oxide which can take the granular structure is, for example, SiO₂, Al₂O₃, TiO₂, Ta₂O₃, ZrO, Y₂O₃, MgO, or the like. Nitride which can take also the granular structure is, for example, TiN, BN, AIN, Si₃N₄, MgO, TaN, or the like. Further, carbide which can take the granular structure is, for example, SiC, TiC, B₄C, TaC, and the like.

Specifically, the relationship between the linear recording density and noise was measured with use of a magnetic recording medium having a non-magnetic metal ground layer 2 having a granular structure by adding SiO₂ to Ru, and a magnetic recording medium using Cr as a ground film.

At this time, the thickness of the non-magnetic metal ground layer 2 was 30 nm, the composite ratios of Ru and SiO₂ in the layer were 80 mol % to 20 mol %. The film thickness of the ground layer made of Cr was 30 nm. Further, magnetic layers 3 each made of Co₇₀Pt₁₁B₇O₁₂ and having a thickness of 15 nm were used. In addition, in each of these magnetic recording media, a non-magnetic substrate 1 made of a disk-like glass plate was used, and a film in which carbon and a lubricant are respectively formed to be 10 nm and 2 nm thick was used as a protect film. Further, a magnetic head having a recording track width of 1.2 μm and a gap length of 0.25 μm, and a reproducing track width of 0.9 μm was used for recording/reproducing.

FIG. 9 shows a result in which this magnetic head was used to perform recording/reproducing to measure the relationship between the linear recording density and noise. In FIG. 9, the lateral axis represents the repetition frequency of recording, i.e., how many times the polarity changed per inch, and the longitudinal axis represents a value which standardizes the integration current of noise by a reproducing output of a low frequency. As can be seen from FIG. 9, the magnetic recording medium having a non-magnetic metal ground layer 2 constructed into a granular structure by adding SiO₂ generates smaller noise irrespective of the linear recording density, compared with the magnetic recording medium using Cr as a ground film. In particular, in the high-density recording area, a great difference from the case of constructing the granular structure is caused by the standardized noise and by adding SiO₂ to Ru in case where Cr is used as a ground film. Hence, it is found that use of the non-magnetic metal ground layer 2 constructed into a granular structure by adding SiO₂ to Ru is suitable for high-density recording because noise is small even when the linear recording density is enlarged.

Meanwhile, in this magnetic recording medium, the magnetic layer 3 has a metal magnetic thin film formed by a thin-film forming method such as a vapor deposition method, a sputtering method, a plating method, or the like. Specifically, a film made of Co and/or Fe or a film obtained by adding to these elements at least one kind selected from a group of Pt, Pd, and Ni can be exemplified as the metal magnetic thin film.

In particular, it is preferable that Co and/or Fe contains a predetermined amount of at least one kind of element selected from a group of Pt, Pd, and Ni in the metal magnetic thin film. Specifically, FIG. 10 shows results in which the relationship between the composite ratio of Pt in the magnetic layer 3 and the coercive force was measured with respect to a plurality of magnetic recording media in which non-magnetic metal ground layers 2 made of Ru₁₀₀ were prepared with different thicknesses. The magnetic films 3 each had a thickness of 10 nm and were formed under an Ar gas pressure of 6 Pa by a DC sputtering method where the temperature of the non-magnetic substrates was set to a room temperature.

As can be seen from FIG. 10, a Co₁₀₀₋ₓPtₓ film using Ru for the non-magnetic metal ground layer 2 has greater coercive force Hc, compared with the case of using Cr for a ground film. Further, the coercive force Hc increases as the thickness of the non-magnetic metal ground layer 2 increases. Particularly, it is found that the effect of improving the coercive force appears conspicuous when the composite ratio of Pt is 20 at %.

It is preferable that the thickness of the magnetic layer 3 is 15 nm or more. By setting the thickness of the magnetic layer 3 to 15 nm or more, the coercive force of the magnetic layer 3 can be remarkably improved by the non-magnetic metal ground layer 2. Specifically, FIG. 11 shows the relationship between the thickness of the magnetic layer 3 and the coercive force. A metal magnetic thin film made of Co₇₅Cr₁₅Pt₁₀ was used for the magnetic layer 3, and Ru₁₀₀ having a thickness of 10 nm was used for the non-magnetic metal ground layer 2.

As can be seen from FIG. 11, the coercive force is maximized when the thickness of the magnetic layer 3 is about 15 nm. High coercive force is obtained in the range where the thickness of the magnetic layer 3 is 15 nm or more. It is hence found that the magnetic layer 3 provides high coercive force by setting the thickness of the magnetic layer 3 to 15 nm or more.

Further, it is preferable to add one kind of element selected from a group of Cr, Mo. W, V, Nb, Zr, Hf, Ta, Ru, Rh, Ir, Ti, B. P, and C or alloy of these elements to the magnetic layer 3. In this manner, the noise component of the magnetic layer 3 is reduced, in addition to the effect of improving the coercive force caused by the non-magnetic metal ground layer 2 including Ru, so that noise reduction is realized.

The amount of the element or alloy to be added is preferably 0.5 at % to 25 at %. When the addition amount of the element or alloy is lower than 0.5 at %, it may be impossible to obtain an effect sufficient for reducing the noise component. When the addition amount of the element or alloy exceeds 25 at %, reduction of the saturated magnetization amount and the coercive force may be increased.

Further, it is preferable to add oxygen and/or nitrogen within a range of 0.2 at % to 15 at % for the purpose of reducing medium noise. When the addition amount of oxygen and/or nitrogen is lower than 0.2 at %, it may be impossible to obtain a sufficient noise reduction effect. When the addition amount of oxygen and/or nitrogen exceeds 15 at %, the coercive force may be lowered.

In addition, it is preferable to add at least one kind of material selected from oxides such as SiO₂, Al₂O₃, TiO₂, Ta₂O₃, ZrO, Y₂O₃, MgO, and the like, nitrides such as TiN, BN, AIN, Si₃N₄, TaN, and the like, and carbides such as SiC, TiC, B₄C, TaC, and the like, to the magnetic layer 3, thereby to form a granular structure in which the selected material and the magnetic layer 3 are finely compounded. Thus, the magnetic layer 3 can reduce the noise component by taking a granular structure constructed by adding at least one kind of material selected from oxides, carbides, and nitrides.

Furthermore, the magnetic layer 3, as shown in FIG. 12, should preferably be formed by layering alternately a plurality of metal magnetic thin films 10 and separation layers 11. The separation layer 11 is made of Ru singly or is made of alloy of Ru and one kind of element selected from a group of Al, Ti, V, Cr, Fe, Mn, Co, Ni, Cu, Y, Zr, Nb, Mo, Rh, Pd, Ag, Hf, Ta, W, Ir, Pt, Au, Si, B, and C. Thus, the noise component of the magnetic layer 3 can be reduced by alternately layering the metal magnetic thin films 10 and the separation layers 11 to form the magnetic layer 3.

In particular, the separation layer 11 should preferably layered as a layer made of at least one kind of material selected from first and second groups where the first group includes Cr, Mo, W, Ti, Ta, Nb, Ni, Cu, Al, V, Zr, Hf, C, B, and Si, and the second group includes oxides such as SiO₂, Al₂O₃, TiO₂, Ta₂O₃, ZrO, Y₂O₃, MgO, and the like, nitrides such as TiN, BN, AlN, Si₃N₄, TaN, and the like, and carbides such as SiC, TiC, B₄C, TaC, and the like. In this case, the separation layer is capable of steadily shutting off magnetic interaction between adjacent metal magnetic thin films 10. Therefore, the magnetic recording medium can steadily reduce noise components and can restrict reduction of the output.

Also, the separation layer 11 can securely shut off magnetic interaction between adjacent metal magnetic thin films 10 by adding at least one kind of material selected from the second group. Accordingly, in this case, the magnetic recording medium can also steadily reduce the noise component and can restrict reduction of the output.

Further, the separation layer 11 may be layered as a layer, which is added with at least one kind of material selected from the second group and is made of at least one of material selected from the first group. In this case, the magnetic recording medium can steadily shut off magnetic interaction between adjacent metal magnetic thin films 10, so that the noise component can be steadily reduced and reduction of the output can be restricted.

Meanwhile, in this magnetic layer 3, the magnetic anisotropy in the vertical direction on the film surface can be enlarged by alternately layering a metal magnetic thin film made of at least one kind of material selected from a group of Co, Ni, and Fe, and an intermediate layer made of at least one kind of material selected from Pt, Pd, and Ni. That is, in this case, it is possible to realize vertical magnetic recording in which signals are written in the direction substantially vertical to the film surface on the magnetic layer 3. In particular, the coercive force of the magnetic layer 3 is improved by forming the magnetic layer 3 on the non-magnetic metal ground layer 2. Therefore, vertical magnetic recording can be achieved with excellent electromagnetic conversion characteristics.

FIG. 13 specifically shows results of measuring the relationship between the film forming gas pressure and the coercive force in the vertical direction, with respect to a magnetic recording medium having a non-magnetic metal ground layer 2 made of Ru and a magnetic recording medium having a ground layer made of Pd. In each of these magnetic recording media, the magnetic layer 3 was an artificial grid film in which films which were 0.4 nm and 0.6 nm thick are layered cyclically and sequentially. Also, in these magnetic recording media, the film thickness of the non-magnetic metal ground layer 2 and that of the ground layer were each 30 nm.

As can be seen from FIG. 13, the magnetic recording medium having a non-magnetic metal ground layer 2 made of Ru has greater coercive force in the direction vertical to the film surface, compared with the magnetic recording medium having a ground layer made of Pd. Hence, it is found that vertical magnetic recording with excellent electromagnetic conversion characteristics can be achieved by forming a magnetic layer 3 for vertical magnetic recording on the non-magnetic metal ground layer 2.

FIG. 14 shows a result of measuring the relationship between the linear recording density and the standardized noise, with respect to a magnetic recording medium having a non-magnetic metal ground layer 2 made of Ru and a magnetic recording medium having a ground layer made of Pd. In each of these magnetic recording media, the magnetic layer 3 was an artificial film in which a Co film having a thickness of 0.4 nm and a Pd film having a thickness of 0.6 nm were cyclically and sequentially layered, and the non-magnetic metal ground layer 2 or the ground layer 3 was formed on a Ti ground layer.

As can be seen from FIG. 14, the magnetic recording medium having a non-magnetic metal ground layer 2 made of Ru generate lower standardized noise at any linear recording density, compared with the magnetic recording medium having a ground layer made of Pd. Hence, it is found that vertical magnetic recording with lower noise component can be achieved by forming a magnetic layer 3 for vertical magnetic recording on the non-magnetic metal ground layer 2.

Meanwhile, it is preferable for this magnetic recording medium to use resin material having plasticity, such as polyethylene terephthalate, polyethylene naphthalate, polycarbonate, or the like, as the non-magnetic substrate 1. By using resin material having plasticity, cyclic convexes and concaves can be formed easily on the main surface of the non-magnetic substrate 1, so that track position detection signals need not be written onto the magnetic layer, leading to excellent mass-productivity. In addition, processing of a desired shape can be achieved by using resin material having plasticity as the non-magnetic substrate 1, so that a magnetic recording medium which can be used for various applications can be realized. Further, material costs, in comparison with a glass substrate or the like, can be greatly reduced by using resin material having plasticity.

The magnetic recording medium constructed as described above can be manufactured by forming a non-magnetic metal ground layer 2 and a magnetic layer 3 in this order on the non-magnetic substrate 1. In particular, in this method, the non-magnetic metal ground layer 2 and the magnetic layer 3 can be each formed at a temperature of 100° C. or less.

The method of forming films of these non-magnetic metal ground layer 2 and the magnetic layer 3 will be a vapor deposition method, a sputtering method, a plating method, or the like. Among these film forming methods, the sputtering method is suitable from the view point of composition control when the non-magnetic metal ground layer 2 and the magnetic layer 3 are made of alloy having a predetermined composite ratio. The method of forming alloy films having a predetermined composite ratio will be a method of using an alloy target, a method of preparing different elements by simultaneous multiple discharging, or the like.

Further, the granular structure described above can be easily prepared also by the sputtering method. The method of preparing a non-magnetic metal ground layer 2 and a magnetic layer 3 which construct a granular structure will be a method of arranging a metal piece on a target which is a mixture of metal and SiO₂ or the like or arranging a ceramics target on a metal target, a method of causing metal and ceramics targets to discharge simultaneously thereby to prepare the structure, or the like.

Further, as a method of mixing oxygen and nitrogen into the non-magnetic metal ground layer 2 and the magnetic layer 3, gases of oxygen and nitrogen may be introduced at a constant rate into a gas atmosphere during sputtering.

As a preparatory step before forming the magnetic layer 3, it is preferable to roughen previously at least a part of the surface of the non-magnetic metal ground layer 2, so as to have a groove-like, irregular groove-like, or island-like shape by a chemical or physical measure through a processing technique generally called texture process. In this manner, the adhesion force between the magnetic layer 3 and the non-magnetic metal ground layer 2 can be improved.

Particularly, in this method, the coercive force of the magnetic layer 3 can be improved without heating over 100° C. because the non-magnetic metal ground layer 2 contains Ru at a ratio of 20 at % or more. Therefore, in this method, the temperature can be set to 100° C. or less when forming the non-magnetic metal ground layer 2 and the magnetic layer 3. In other words, according to this method, a magnetic layer 3 having high coercive force can be formed even when the non-magnetic metal ground layer 2 and the magnetic layer 3 are formed under the temperature condition of 100° C. or less. Thus, according to this method, increase of noise due to heating is prevented so that a magnetic recording medium having a magnetic layer with high coercive force and less noise component.

Also, according to this method, deformation of the non-magnetic substrate 1 can be prevented even when resin material having plasticity is used for the non-magnetic substrate 1 because the temperature is set to 100° C. or less when forming the non-magnetic metal ground layer 2 and the magnetic layer 3. Therefore, according to this method, a magnetic recording medium having excellent flatness can be prepared even when resin material having plasticity is used for the non-magnetic substrate 1.

In the following, embodiments of the present invention and a comparative example will be explained with reference to Table 1. In each of the embodiments and comparative example shown in the Table 1, the non-magnetic metal ground layer and the magnetic layer were formed by the sputtering method under the temperature condition of 100° C. or less.

TABLE 1

| | Magnetization | | Non-magnetic metal | Magnetic layer | Coercive force |
|---|---|---|---|---|---|
| | direction | Ground layer | ground layer | structure | (KOe) |
| Embodiment 1 | In film | — | Ru₁₀₀ 50 nm | Co₇₀Ni₃₀ 10 nm | 1.8 |
| | surface | | | | |
| Embodiment 2 | In film | Ti 10 nm | Ru₇₂B₂₈ 20 nm | Co₈₀Pt₁₂Ta₈ 14 nm | 3.3 |
| | surface | | | | |
| Embodiment 3 | In film | Cr 30 nm | Ru₈₇B₈N₅ 30 nm | 80 mol % Co₈₀Pt₂₀ - | 3.5 |
| | surface | | | 20 mol % BN 18 nm | |
| Embodiment 4 | In film | Cr 10 nm | 70 mol % Ru - | 70 mol % Co₇₀Pt₃₀ - | 4.0 |
| | surface | | 30 mol % SiO₂ 25 nm | 30 mol % SiO₂ 20 nm | |
| Embodiment 5 | Vertical to | Ta 5 nm | Ru₈₅Cu₁₅ 20 nm | [Co(0.3 nm)/Pt (1 nm)] × | 4.3 |
| | film surface | | | 22 | |
| Comparative | In film | Cr 50 nm | — | Co₇₀Ni₃₀ 10 nm | 0.3 |
| example 1 | surface | | | | |

As shown in this Table 1, the embodiments 1 to 5 in each of which Ru is contained at 20 at % or more in the non-magnetic metal ground layer show higher coercive force, compared with the comparative example in which a magnetic layer is formed on the Cr ground layer.

Further embodiments each having a magnetic layer 3 which has a metal magnetic thin film 10 and a separation layer 11 as shown in FIG. 12 were prepared, and noise reduction effects were discussed. At this time, in each of the embodiments, a Mo ground layer having a film thickness of 20 nm was formed on a non-magnetic substrate, a non-magnetic metal ground layer made of Ru₉₅—O₅ and having a film thickness of 30 nm was formed on the Mo ground layer. A Co₇₀Pt₃₀ film having a film thickness of 7 nm was formed as a first magnetic film on the non-magnetic metal ground layer. A separation layer was formed on the first magnetic film. Further, another film which is the same as the first magnetic layer was formed as a second magnetic layer on the separation layer. Embodiments 6 to 8 were thus prepared. Another embodiment 9 including no separation layer was also prepared for comparison. The separation layer structures, signal outputs, and S/N values of these embodiments 6 to 9 are shown in Table 2.

TABLE 2

| | | Signal output | |
|---|---|---|---|
| | Structure of separation layer | (mVp-p) | S/N (dB) |
| Embodiment 6 | Ru 3 nm | 0.9 | 28 |
| Embodiment 7 | Cr 2 nm/Ru 1 nm | 1.2 | 36 |
| Embodiment 8 | SiO₂ 2 nm/80 mol % Ru - | 1.1 | 37 |
| | 20 mol % SiO₂ 2 nm | | |
| Embodiment 9 | No separation layer | 1.3 | 32 |

As shown in this Table 2, the embodiments 7 to 8 each provided with a separation layer achieved excellent S/N, compared with the embodiment 9 including no separation layer. In case of the embodiment 6 in which the separation layer is made of Ru₁₀₀ with a thickness of 3 nm, the effect of reducing magnetic interaction between the first and second magnetic films is so weak that the S/N cannot be much excellent. However, in the embodiment 6, the coercive force is improved due to the non-magnetic metal ground layer.

Further, values of the coercive force was measured for each of the embodiments 9 to 11 in which the non-magnetic substrates were replaced with various materials. Table 3 shows the results of the measurement. In each of these embodiments 9 to 11, the film thickness of the non-magnetic metal ground layer was made of Ru₅₀—Mo₅₀ with a film thickness of 40 nm, and the magnetic layer was made of Co₆₆—Pt₁₅—B₉—O₁₀.

TABLE 3

| | | Coercive force |
|---|---|---|
| | Material of non-magnetic substrate | (kOe) |
| Embodiment 10 | Glass | 3.8 |
| Embodiment 11 | Polyethylene-terephthalate | 3.8 |
| Embodiment 12 | Plastics | 3.7 |

As shown in this Table 3, excellent coercive force is attained even if the non-magnetic substrate is made of any material. Hence, variety of choice of material for the non-magnetic substrate can be broadened by providing a non-magnetic metal ground layer.

1. A magnetic recording medium comprising:
a non-magnetic substrate;
a non-magnetic metal ground layer formed on a main surface side of the non-magnetic substrate and containing Ru at 20 at % or more; and
a magnetic layer formed on the non-magnetic metal ground layer and having a metal magnetic thin film.

2. The medium according to claim 1, wherein the non-magnetic metal ground layer is constructed by layering a plurality of layers which have different compositions from each other.

3. The medium according to claim 1, wherein the non-magnetic metal ground layer has such a graded composition in which a composition of the non-magnetic metal ground layer changes sequentially in a film thickness direction.

4. The medium according to claim 1, wherein the non-magnetic metal ground layer is made of alloy of Ru and at least one kind of material selected from Cr, Ti, Ta, Zr, Hf, Fe, Co, Mn, Si, Al, Ag, Au, and Ir, and a composite ratio of Ru in the alloy is set to 50 at % or more.

5. The medium according to claim 1, wherein the non-magnetic metal ground layer is made of alloy of Ru and at least one kind of material selected from W, Mo, V, Nb, and B, and a composite ratio of Ru in the alloy is set to 20 at % or more.

6. The medium according to claim 1, wherein the non-magnetic metal ground layer is made of alloy of Ru and at least one kind of material selected from Cu, Ni, Pd, Pt, Y, and C, and a composite ratio of Ru in the alloy is set to 80 at % or more.

7. The medium according to claim 1, wherein the non-magnetic metal ground layer contains oxygen and/or nitrogen.

8. The medium according to claim 7, wherein the oxygen and/or nitrogen is contained at a composite ratio of 0.2 to 10 at % in the non-magnetic metal ground layer.

9. The medium according to claim 1, wherein the non-magnetic metal ground layer is constructed by at least one kind selected from oxide, nitride, carbide, and carbon formed in a granular structure.

10. The medium according to claim 9, wherein the oxide includes at least one kind of material selected from SiO₂, Al₂O₃, TiO₂, Ta₂O₃, ZrO, Y₂O₃, and MgO, the nitride is at least one kind of material selected from TiN, BN, AIN, Si₃N₄, and TaN, and the carbide is at least one kind of material selected from SiC, TiC, B₄C, and TaC.

11. The medium according to claim 1, wherein the magnetic layer is constructed by layering a plurality of metal magnetic thin films, with at least one intermediate layer inserted therebetween, the intermediate layer being made of at least one kind of material selected from Pt, Pd, and Ni.

12. The medium according to claim 1, wherein the magnetic layer contains at least one kind of material selected from Cr, Mo, W, V, Nb, Zr, Hf, Ta, Ru, Rh, Ir, Ti, B, P, and C at 0.5 to 25 at %.

13. The medium according to claim 1, wherein the magnetic layer contains oxygen and/or nitrogen at 0.2 to 15 at %.

14. The medium according to claim 1, wherein the magnetic layer is constructed by at least one kind selected from oxide, nitride, and carbide, formed in a granular structure.

15. The medium according to claim 1, wherein the magnetic layer is constructed by layering a plurality of metal magnetic thin films, with at least one separation layer inserted therebetween, the separation layer being made of Ru singly or alloy of Ru and at least one kind of material selected from Al, Ti, V, Cr, Fe, Mn, Co, Ni, Cu, Y, Zr, Nb, Mo, Rh, Pd, Ag, Hf, Ta, W, Ir, Pt, Au, Si, B, and C.

16. The medium according to claim 15, wherein the separation layer is layered as a layer made of at least one kind of material selected from a first group of Cr, Mo, W, Ti, Ta, Nb, Ni, Cu, Al, V, Zr, Hf, C, B, and Si, and a second group of oxide, nitride, and carbide, the oxide including SiO₂, Al₂O₃, TiO₂, Ta₂O₃, ZrO, Y₂O₃, and MgO, the nitride including TiN, BN, AIN, Si₃N₄, and TaN, and the carbide including SiC, TiC, B₄C, and TaC, the separation layer is mixed with at least one kind of material selected from the second group, or the separation layer is mixed with at least one kind of material selected from the first and second groups.

17. A method of manufacturing a magnetic recording medium, comprising:
a step of forming a non-magnetic metal ground layer containing Ru at 20 at % or more, on one main surface side of the non-magnetic substrate, under a condition of 100° C. or less; and
a step of forming thereafter a magnetic layer having a metal magnetic thin film, on the non-magnetic metal ground layer, under a condition of 100° C. or less.

18. The method according to claim 17, wherein the non-magnetic metal ground layer and the magnetic layer are formed by a sputtering method.
